(19) United States
(12) Patent Application Publication
(10) Pub. No.: US 2006/0111877 A1
(43) Pub. Date: May 25, 2006

(54) System and method for processing a series of image frames representing a cardiac cycle

(76) Inventors: Eltjo Hans Haselhoff, Eindhoven (NL); Kay Nehrke, Ammersbek (DE); Peter Boernert, Hamburg (DE)

Correspondence Address: PHILIPS INTELLECTUAL PROPERTY & STANDARDS, 595 MINER ROAD, CLEVELAND, OH, 44143, US

(21) Appl. No.: 10/538,528

(22) PCT Filed: Nov. 28, 2003
(86) PCT No.: PCT/IB03/05511

§ 371 Date: Jun. 10, 2005

(30) Foreign Application Priority Data
Dec. 13, 2002 (EP) 02080278.1
Apr. 11, 2003 (EP) 03100984.8

(51) Int. Cl. G06F 15/00

(52) U.S. Cl. 702/193

(57) ABSTRACT

The invention relates to a system for processing a series of image frames representing a cardiac cycle, at least comprising input or data collection means for collecting the series of image frames, a memory inter alia for storing and retrieving said series of image frames, a processor for processing the frames, and display means, whereby in use the processor processes the frames to identify from said series of images a frame or frames representing a pre-determined phase of the cardiac cycle whereby the processor compares images from said series of image frames and establishes a measure of identity between such frames, whereby the processor applies said measure of identify to identify the phase of the cardiac cycle pertaining to such frames.

The invention relates to a system for processing a series of image frames representing a cardiac cycle, at least comprising input or data collection means for collecting the series of image frames, a memory inter alia for storing and retrieving said series of image frames, a processor for processing the frames, and display means, whereby in use the processor processes the frames to identify from said series of images a frame or frames representing a pre-determined phase of the cardiac cycle.

The invention further relates to a method for processing a series of image frames representing a cardiac cycle in order to identify from said series of images a frame or frames representing a pre-determined phase of the cardiac cycle.

Such a system and method are known from WO 01/82787. Generally it is required to identify the systolic phase and the diastolic phase of a heart under examination in order to be able to determine further heart parameters such as the stroke volume, the ejection fraction and other parameters. Normally, the systolic phase and the diastolic phase of the heart can be easily determined by means of an ECG-signal. When, however, such an ECG-signal is not available or when it is not possible to avail of this ECG-signal the problem occurs that in order to be able to assess a variety of heart parameters it is a prerequisite that an accurate determination of the systolic phase and the diastolic phase of the heart are determined.

Although the invention is applicable to the selection of the image frames that show the heart in its systolic phase and in its diastolic phase, the invention is not restricted to only this purpose but can be used to identify also other phases in the heart's cardiac cycle.

WO 01/82787 relates to an automatic method for evaluating image data taken over a sequence of image frames in order to determine a contour of a left ventricle of a heart under examination. According to this known art end diastole and end systole aortic valve points are entered whereby an initial end diastole region/end systole region classifier is developed using a probability look-up table. Also provided are training data determined from manually drawn contours of hearts of other individuals than the person under examination. Regression coefficients derived from the training data are then applied to determine the end diastole boundary and the end systole boundary which can be used to calculate an ejection fraction for the heart. This known method is complicated and requires much manual input in order to be able to obtain the diastole and systole boundaries of the heart.

It is an object of the invention to provide a system which effectively identifies the frames that are representative for a predetermined phase of the cardiac cycle of the heart under examination. A further object is that the manner of operation of this system may be automatic, will allow the ease of processing the series of image frames, and is simple to implement.

The invention is embodied in a method and system and furthermore in software and a data carrier comprising this software as specified in the appended claims.

In a first aspect of the invention the system for processing a series of image frames representing a cardiac cycle is characterized in that the processor compares images from said series of image frames and establishes a measure of identity between such frames, whereby the processor applies said measure of identity to identify the phase of the cardiac cycle pertaining to such frames.

Practice has shown that the system according to the invention provides robust means to identify the phase of the cardiac cycle which is of interest for the examination.

A first preferred embodiment of the system according to the invention is characterized in that the processor compares consecutive frames from the series of images, and selects from the series of images the frames showing the highest value of the measure of identity as pertaining to the systolic resting-phase and the diastolic resting-phase of the cardiac cycle. Preferably the processor compares pairs of consecutive frames.

Apart from the property that the system according to the invention may carry out the identification of the concerning phase of the cardiac cycle completely automatic a further property lies in that the determination of the different cardiac phases is easy. The phases are simply related to such frames that show the highest value of identity in case the most quiescent heart phases are intended to discover, i.e. the systolic resting-phase and the diastolic resting-phase. If on the other hand one wishes to detect the heart phase with the most prominent motion one has to select in this embodiment the frames showing the lowest value of the measure of identity.

In another preferred embodiment of the system according to the invention the processor compares each frame from said series with every other frame from the series of images, and selects a first frame and a second frame from said series of images showing the lowest value of said measure of identity, whereby the first frame and the second frame are identified to pertain to the systolic resting-phase and the diastolic resting-phase of the cardiac cycle.

All embodiments of the system according to the invention allow to determine the phase of the heart under examination, for instance, the systolic phase and the diastolic phase from a series of image frames representing a complete cardiac cycle without the need to rely on further measurements such as the ECG-signal.

A further aspect is that the system can be applied on any type of image frames such as the image frames derived from a CT-scan, a MRI-scan or an ultrasound scan, although the system is particularly useful when applied on a series of images that are derived from a MRI-scan. When collecting a series of image frames with a MRI-scan the problem is that the ECG-signal that is otherwise available can not be used because the ECG corrupts the MRI-frames on the one hand, whereas on the other hand the ECG-signal is disturbed by the magnetic fields of the MRI-scan.

In practice it appears that any suitable way of comparing the frames is feasible. The system according to the invention preferably however compares the frames by executing a cross-correlation function with regard to such frames whereby it assigns the value resulting from said cross-correlation as representing the said measure of identity.

In a further preferred embodiment the processor compares the image frames with reference to and restricted to a pre-selected area of the images on the frames. In this way the identification of the sought for heart phase can be supported by a proper selection of the area which is used for comparison.

Suitably the comparison is made by selecting the area which represents the right coronary artery and its immediate surroundings.

Hereinafter the invention will be further elucidated with reference to the following non-limiting exemplary embodiments of the system and method according to the invention, and with reference to the annexed figures.

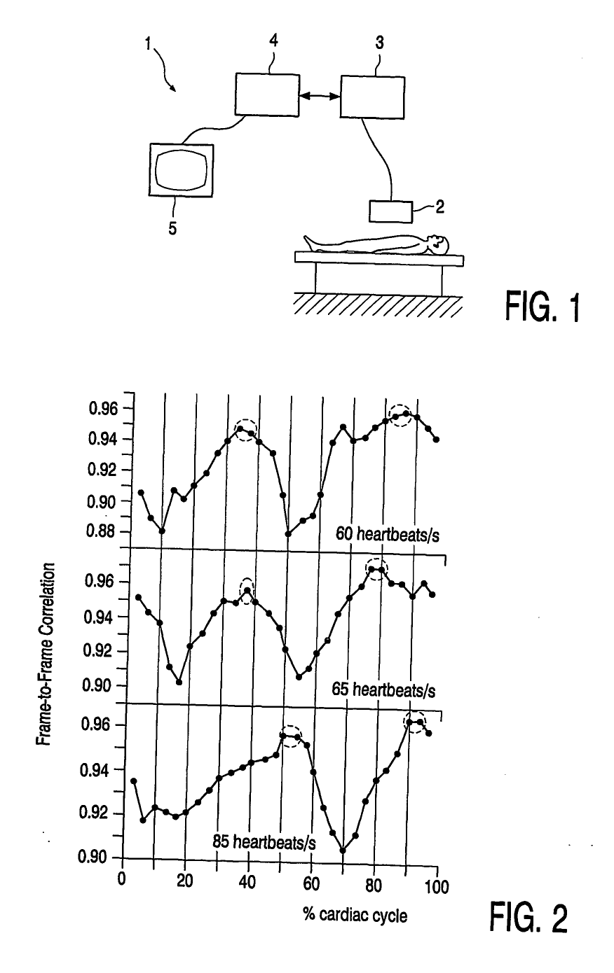

FIG. 1 shows the system according to the invention.

FIG. 2 shows results obtained with a first embodiment of the system according o the invention.

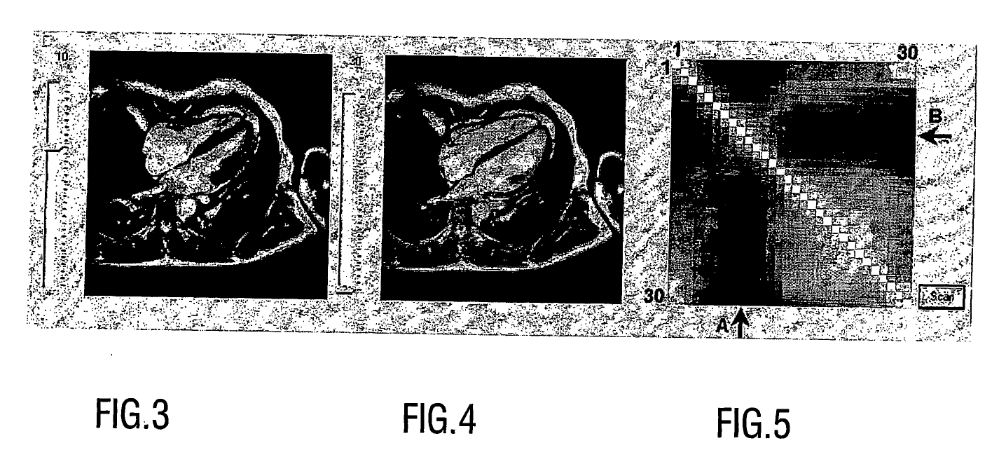

FIGS. 3 and 4 show two image frames selected from a series of image frames representing a complete cardiac cycle.

FIG. 5 shows the result obtained with a second embodiment of the system according to the invention.

Referring now first to FIG. 1 the system for processing a series of image frames representing a cardiac cycle is indicated in general with reference numeral 1. This system 1 at least comprises input or data collection means 2 for collecting of image frames from the heart under examination. These image frames may be inputted into the system 1 off-line or on-line meaning that the input or data collection means may be a CT-scan-, a MRI-scan- or an ultrasound-scan apparatus, or the apparatus may be a memory device or a computer carrying the data from the concerning scan.

The said input or data collection means 2 are connected to a memory 3 which is inter alia intended for storing and retrieving the series of image frames. The memory 3 is in turn connected to a processor 4 for processing the frames and display means 5 which is intended to show results of the processing and/or the frames that are being processed.

When the system 1 is in use the processor 4 processes the frames to identify from the series of image frames such frame or frames that represent a predetermined phase of the cardiac cycle. For this purpose the processor 4 compares-images from the series of image frames and establishes a measure of identity between such frames whereby the processor 4 applies said measure of identity to identify the phase of the cardiac cycle to pertaining to such frames.

In a first embodiment of the system 1 according to the invention the processor 4 compares consecutive frames from the series of images and selects the frames showing within these series of images the highest value of the measure of identity as pertaining to the systolic resting-phase and the diastolic resting-phase of the cardiac cycle. Preferably this is done such that the processor 4 compares pairs of consecutive frames.

In an exemplary application of this first embodiment the system made use of a clinical 1.5 T-scanner of the make Gyroscan ACS-NT15 marketed by Philips Medical Systems. After completion of a multi-heart phase cine scan, the global cross-correlation within each pair of consecutive cine images was determined by the system. Through this global cross-correlation function pertaining to the frames a direct measure of the differences, or in other words the measure of identity between successive images was determined and it was shown that this measure of identity represents a robust measure for the relative changes between the consecutive images.

Experiments were carried out on seven healthy volunteers and two-dimensional ECG-gated breath-hold series of image frames were obtained wherein the field of view measured 320 mm×224 mm. Thirty (30) heart phases were measured. A transversal orientation was chosen containing the intersection with the right coronary artery which proved to be preferable in view of the motion amplitude of this part being larger than that of the left system of the heart. A comparison was made with the visually determined rest periods of the right coronary artery and compared to the frame positions where a maximum of the correlation curves occurred.

FIG. 2 shows the correlation graph for three selected volunteers in which the X-axis shows the development of a complete cardiac cycle and the Y-axis shows the correlation value depending on the frame position within the cardiac cycle. The visually derived rest periods corresponding to the end diastolic and end systolic phase of the heart coincide with the frames that show the highest value of the measure of identity as determined by the cross-correlation function that the system according to the invention preferably applies.

In a second embodiment the processor 4 of the system 1 according to the invention compares each frame from said series of image frames with every other frame from the series and selects a first frame and a second frame from said series of images showing the lowest value of said measure of identity whereby the first frame and the second frame are identified to pertain to the systolic resting-phase and the diastolic resting-phase of the cardiac cycle.

The results of the system working according to this embodiment are shown in FIGS. 3, 4 and 5. FIGS. 3 and 4 show a human heart at different moments of the cardiac cycle. A typical cardiac cycle consists of at least thirty of such frames as shown in FIGS. 3 and 4 respectively.

According to the invention each frame from the series of frames (such as the frames shown in FIGS. 3 and 4) is compared with every other frame from the series of frames and the result of the comparison is converted into a measure of identity.

FIG. 5 shows the collected measures of identity for all the possible combinations of pairs of frames from the series of frames representing a complete cardiac cycle. In this particular case FIG. 5 shows on both the horizontal and the vertical axis all frames from one series of frames, numbered 1-30, resulting in a total of ½N.(N+1) possible combinations in which N=30 is the total number of frames.

FIG. 5 shows the result of the comparison whereby the white areas represent full identity between the two compared frames and the darker areas represent less correspondence between the compared frames. The darkest areas represent the least correspondence between the compared frames.

Based on the above the areas marked with the arrows A and B relate to the combinations of frames showing the largest differences between the compared frames. Based on this result the systolic frame showing the contraction of the heart and the diastolic frame showing the heart in relaxed condition can be identified as frames 10 and 30 respectively.

Finally, it is remarked that the invention is not restricted to use with MRI-scans only. It can easily well be applied with CT-scans, ultrasound scans and any other scan that may be developed in future.

The invention can further easily well be applied with image frames from the heart taken from a perspective that differs from the frames shown in FIGS. 3 and 4 respectively. The invention is insensitive to the viewing direction at which the heart under examination is being monitored. In short: the invention is not limited to the specific embodiments discussed above. This discussion merely serves to elucidate the appended claims without intending to limit the scope of protection of these claims.

1. System for processing a series of image frames representing a cardiac cycle, at least comprising input or data collection means for collecting the series of image frames, a memory inter alia for storing and retrieving said series of image frames, a processor for processing the frames, and display means, whereby in use the processor processes the frames to identify from said series of images a frame or frames representing a pre-determined phase of the cardiac cycle, wherein the processor compares images from said series of image frames and establishes a measure of identity between such frames, whereby the processor applies said measure of identify to identify the phase of the cardiac cycle pertaining to such frames.

2. System according to claim 1, wherein the processor compares consecutive frames from the series of images, and selects from the series of images the frames showing the highest value of the measure of identity as pertaining to the systolic resting-phase and the diastolic resting-phase of the cardiac cycle.

3. System according to claim 2, wherein the processor compares pairs of consecutive frames.

4. System according to claim 1, wherein the processor compares each frame from said series with every other frame from the series of images, and selects a first frame and a second frame from said series of images showing the lowest value of said measure of identity, whereby the first frame and the second frame are identified to pertain to the systolic resting-phase and the diastolic resting-phase of the cardiac cycle.

5. System according to claim 1, wherein the processor compares the frames by executing a cross-correlation function with regard to such frames, whereby it assigns the value resulting from said cross-correlation as representing the said measure of identity.

6. System according to claim 1, wherein the processor compares the image frames with reference to and restricted to a pre-selected area of the images on the frames.

7. System according to claim 6, wherein the pre-selected area is the right coronary artery and its immediate surroundings.

8. Software for use is conjunction with a processor for processing a series of image frames in order to identify from said series of images a frame or frames representing a pre-determined phase of the cardiac cycle, wherein it includes an algorithm to establish a measure of identify between frames of the series of image frames, and to determine from said measure of identity the phase of the cardiac cycle to which the frames relate.

9. Data carrier embodied with software according to claim 8.

10. Method for processing a series of image frames representing a cardiac cycle in order to identify from said series of images a frame or frames representing a pre-determined phase of the cardiac cycle, wherein images from said series of image frames are compared to establish a measure of identity between such frames and that the measure of identity is used to identify the phase of the cardiac cycle pertaining to such frames.

11. Method according to claim 10, wherein consecutive frames from the series of images are compared and that the frames within the series of images are selected that show the highest value of the measure of identity as pertaining to the systolic resting-phase and the diastolic resting-phase of the cardiac cycle.

12. Method according to claim 10, wherein each frame from the series of image frames is compared with every other frame from the series, and a first frame and a second frame from said series of images showing the lowest value of said measure of identity are selected, whereby the first frame and the second frame are identified to pertain to the systolic resting-phase and the diastolic resting-phase of the cardiac cycle.
